(19) United States
(12) Patent Application Publication
(10) Pub. No.: US 2013/0064619 A1
(43) Pub. Date: Mar. 14, 2013

(54) METHOD OF MACHINING SLOTS IN A TURBINE DISK OF A TURBINE ENGINE

(71) Applicants: Olivier Belmonte, Perthes en Gatinais (FR); Jean-Pierre Leboulanger, Chartrette (FR); Bruno Varone, Corbeil-Essonnes (FR); Lionel Rene Henri Weller, Champcueil (FR)

(72) Inventors: Olivier Belmonte, Perthes en Gatinais (FR); Jean-Pierre Leboulanger, Chartrette (FR); Bruno Varone, Corbeil-Essonnes (FR); Lionel Rene Henri Weller, Champcueil (FR)

(73) Assignee: SNECMA, Paris (FR)

(21) Appl. No.: 13/699,684

(22) PCT Filed: May 12, 2011
(86) PCT No.: PCT/FR11/51069

§ 371 Date: Nov. 23, 2012

(30) Foreign Application Priority Data
May 27, 2010 (FR) 1054110

(51) Int. Cl. B23C 3/30; B23C 7/00; F01D 5/30

(52) U.S. Cl. 409/132; 416/219 R; 409/234

(57) ABSTRACT

A machining method for machining peripheral slots in a disk of a turbine of a turbine engine, such as an airplane turboprop or turbojet, the method including: machining the slots by reaming using a substantially cylindrical reamer of length greater than an axial thickness of the disk, and extending substantially parallel to the axis of the disk, outlines of the slots being machined by moving the reamer perpendicularly to its axis along the profile of each slot.

The present invention relates to a method of machining slots in a turbine disk of a turbine engine, such as an airplane turboprop or turbojet.

A turbine of this type generally comprises a plurality of bladed wheels, each comprising a disk with slots formed in its outer periphery for receiving respective blade roots, the slots being regularly distributed around the axis of the disk. At its radially inner end, each blade has an inner platform connected to a root, and at its radially outer end it has an outer platform carrying outer wipers that are for co-operating in operation with blocks of abradable material fastened to the stator of the turbine so as to form labyrinth sealing gaskets;

The slots are generally machined by broaching. In that technique, the cutting tool used is a rectilinear broach having a series of teeth that are longitudinally spaced apart from one another. Each slot is made by moving the broach in rectilinear manner relative to the disk so that the outer periphery of the disk is machined tooth after tooth. The shapes and the sizes of the teeth vary from one end of the broach to the other, with the shape and the size of the last tooth that is to machine the disk corresponding to the shape and the size of the slot. As a general rule several broaches are used in succession so that the final section of the slot that is to be obtained is approached progressively, broach by broach. That operation is repeated for each of the slots to be made.

It can be understood that such a method is time consuming to perform and requires a large amount of space due to the considerable length of the broaches that may lie in the range 6 meters (m) to 8 m.

In addition, a turbine has a plurality of disks that are assembled together. Machining slots by broaching can be performed for only one disk at a time since it is necessary to have access to both sides of the disk, and it is necessary for this access to be available over considerable lengths. The disks therefore need to be machined separately and then assembled together close to one another.

Finally, such a machining technique cannot be used with all materials. In particular, it is not possible to use the broaching technique when the disk is made of a nickel-based alloy, an alloy for which the machinability rating is twice that of a conventional alloy based on titanium.

In order to solve those drawbacks in part, document US 2009/0187269 proposes a method of machining a disk that consists in machining each slot with a shaped tool. The section of the tool corresponds to the section of the slot that is to be obtained, the axis of the tool being substantially radial relative to the disk and the tool being moved from one face of the disk to the other parallel to the axis of the disk in order to form the slot.

Machining by using a shaped tool is nevertheless not suitable for slots of small section or for disks of nickel-based alloy because of the fragility of tools of that type. In addition, for each shape of slot, it is necessary to begin by making a tool of corresponding shape, which is expensive and makes it necessary to change the tool very frequently, since the profile of the tool, once worn, no longer corresponds to the profile of the slot to be made.

A particular object of the invention is to provide a solution to that problem that is simple, effective, and inexpensive.

To this end, the invention provides a machining method for machining peripheral slots in a turbine disk of a turbine engine, such as an airplane turboprop or turbojet, the method being characterized in that it consists in machining the slots by reaming using a substantially cylindrical reamer of length greater than the axial thickness of the disk, and extending substantially parallel to the axis of the disk, the outlines of the slots being machined by moving the reamer perpendicularly to its axis along the profile of each slot.

Thus, the reamer penetrates into the outer periphery of the disk not axially, but radially, such that the method can be used even when all of the disks are assembled together and not very far apart. Furthermore, the cylindrical reamer is a conventional reamer and is less fragile than a shaped tool, thus making it possible to machine materials that are very difficult to machine, such as nickel-based alloys. Finally, the same reamer can be used to machine slots of a plurality of different shapes.

According to another characteristic of the invention, the direction of rotation of the reamer is such that the reaming is performed by climb milling, i.e. the direction of advance of the teeth of the reamer corresponds to the direction of advance of the reamer relative to the material that is to be machined.

Reaming by climb milling generates less vibration and improves cutting quality.

Naturally, reaming could also be performed in the opposite or “conventional” direction, i.e. with the direction of advance of the teeth of the reamer being opposite to the direction of advance of the reamer relative to the material for machining.

According to another characteristic of the invention, the turbine disk is a low pressure turbine disk, which is made of nickel-based alloy.

In an implementation of the invention, the reamer is held at each of its ends by a tool support, at least one of the ends of the reamer being driven in rotation by drive means.

Holding the reamer in this way serves to limit deformation of the reamer and consequently to limit wrongly dimensioning the machined slot, while also limiting any risk of breaking the tool.

The reamer may be made of tungsten carbide, of ceramic, or of high-speed steel (HSS).

In preferred manner, the reamer has two to eight teeth, the helix angle of the reamer, i.e. the angle between the axis of the reamer and the inclination of the teeth, lying in the range 10° to 20°.

Preferably, the cutting speed of the reamer lies in the range 40 meters per minute (m/min) to 70 m/min.

More particularly, the cutting speed lies in the range 60 m/min to 70 m/min when the disk is made of a titanium-based alloy, and lies in the range 40 m/min to 50 m/min when the disk is made of a nickel-based alloy, and when the tools are made of tungsten carbide. The cutting speeds may be faster with tools made of ceramic.

Advantageously, the machining method includes at least a blanking stage and a finishing stage.

The invention also provides a turbine of a turbine engine, such as an airplane turboprop or turbojet, characterized in that it includes at least one disk machined by executing the above-described method.

The invention also provides a reaming tool, in particular for machining peripheral slots in a turbine disk of a turbine engine, the tool being characterized in that it comprises a reamer support with two parallel arms, each having an end containing a respective end of a reamer, and means for driving at least one of the ends of the reamer in rotation.

Advantageously, the reamer is cylindrical.

The invention can be better understood and other details, characteristics, and advantages of the invention appear better on reading the following description made by way of non-limiting example and with reference to the accompanying drawings, in which:

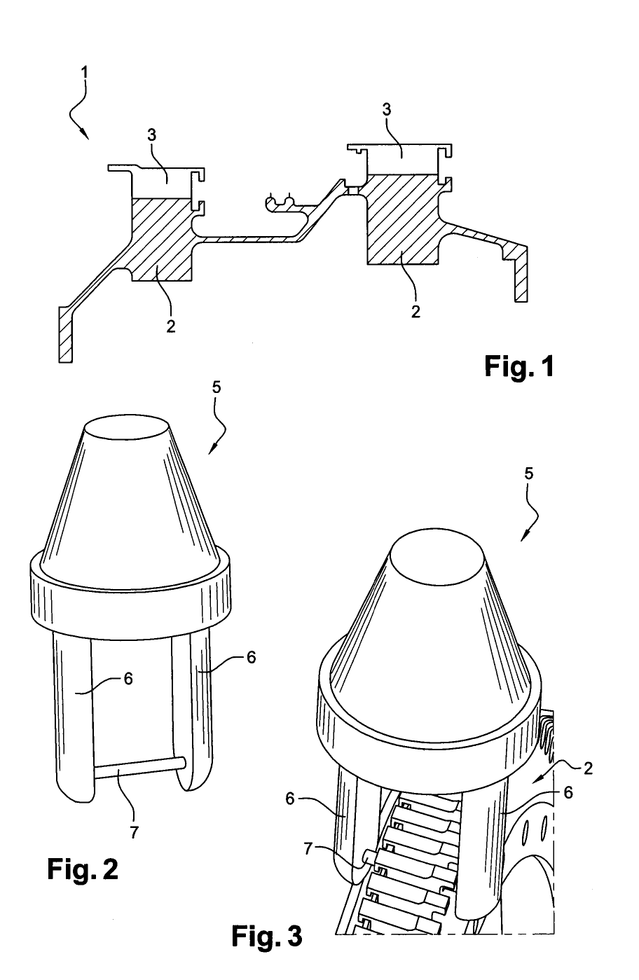

FIG. 1 is a fragmentary section view of an assembly of two disks of a low pressure turbine of a turbojet;

FIG. 2 is a diagrammatic perspective view of a reamer and of its support;

FIG. 3 is a perspective view showing the reaming of a slot in one of the disks of FIG. 1;

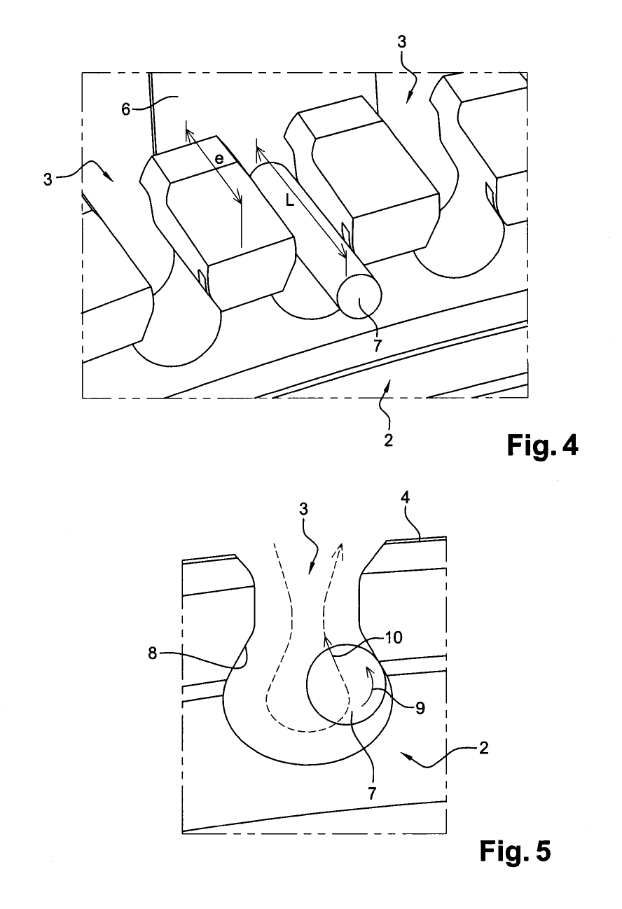

FIG. 4 is a detail view in perspective showing the reaming of the slot, with only one support arm of the reamer being shown; and

FIG. 5 is a diagrammatic face view of the slot showing the direction of rotation of the reamer and the travel direction thereof inside the slot.

FIG. 1 represents an assembly 1 of two disks 2 in a low pressure turbine of an airplane turbojet. Each assembly 1 is made by welding together the two disks 2, the welding bead as formed in this way subsequently being subjected to heat treatment.

The low pressure turbine comprises a plurality of assemblies 1 of this type fastened together by being bolted to one another.

Each disk 2 is made of a nickel-based alloy, and includes dovetailed slots 3 opening out into its outer periphery 4 for the purpose of co-operating with blade roots (not shown).

Attention is paid more particularly below to the machining of these slots 3. For this purpose, a reamer is used having a reamer support 5 with two parallel arms 6, the ends of the arms each carrying a respective end of a cylindrical reamer 7. The reamer 7 is of length L greater than the axial thickness e of the disk 2 and it is made of tungsten carbide or HSS. It has two to eight teeth, with the helix angle of the reamer 7, i.e. the angle between the axis of the reamer 7 and the inclination of its teeth, lying in the range 10° to 20°. The diameter of the reamer is less than its length.

The reamer support 5 also has means for imparting rotary drive to at least one end of the reamer 7, which means are known in the prior art.

In order to machine a slot 3 in a disk 2, the reamer 7 is moved radially towards the outer periphery 4 of the disk 2, with the axis of rotation of the reamer extending parallel to the axis of the disk. The reamer 7 is then urged into the material, with the outline 8 of the slot 3 being machined by moving the reamer 7 perpendicularly to its axis along the profile of the slot 3 (the profile of the slot being its shape in section on a plane perpendicular to the axis of the disk).

Given the length L of the reamer 7, it projects from either side of the disk 2, with the support arms 6 of the reamer support 5 extending on either side of the disk 2.

As shown in FIG. 5, the direction of rotation 9 of the reamer is such that reaming is performed by climb milling, i.e. the direction in which the teeth of the reamer 7 advance corresponds to the direction 10 in which the reamer advances relative to the material that is to be machined. This makes it possible to limit vibration of the reamer, and thus to improve the quality of the machining it performs. The cutting rate of the reamer 7 lies in the range 40 m/min to 70 m/min.

The method may include at least a blanking stage and a finishing stage, and each stage may include one or more passes.

The same method is repeated for each slot 3 in each disk 2.

1-12. (canceled)

13. A machining method for machining peripheral slots in a turbine disk of a turbine engine, or an airplane turboprop or turbojet, the method comprising:
machining the slots by reaming using a substantially cylindrical reamer of length greater than an axial thickness of the disk; and
extending outlines of the slots substantially parallel to the axis of the disk, the outlines of the slots being machined by moving the reamer perpendicularly to its axis along the profile of each slot.

14. A machining method according to claim 13, wherein the direction of rotation of the reamer is such that the reaming is performed by climb milling, and a direction of advance of teeth of the reamer corresponds to a direction of advance of the reamer relative to the material that is to be machined.

15. A machining method according to claim 13, wherein the turbine disk is a low pressure turbine disk.

16. A method according to claim 13, wherein the disk is made of nickel-based alloy.

17. A machining method according to claim 13, wherein the reamer is held at each of its ends by a tool support, at least one of the ends of the reamer being driven in rotation by drive means.

18. A machining method according to claim 13, wherein the reamer is made of tungsten carbide or of high-speed steel.

19. A machining method according to claim 13, wherein the reamer has two to eight teeth, and a helix angle of the reamer, which is an angle between the axis of the reamer and inclination of the teeth, is in a range of 10° to 20°.

20. A machining method according to claim 13, wherein the cutting speed of the reamer lies in a range of 40 in/min to 70 m/min.

21. A machining method according to claim 13, further comprising at least a blanking stage and a finishing stage.

22. A turbine of a turbine engine of an airplane turboprop or turbojet, comprising at least one disk machined by performing the method according to claim 13.

23. A reaming tool, or a reaming tool for machining peripheral slots in a turbine disk of a turbine engine, the tool comprising:
a reamer support with two parallel arms, each having an end including a respective end of a reamer; and
means for driving at least one of the ends of the reamer in rotation.

24. A reaming tool according to claim 23, wherein the reamer is cylindrical.
